(19) United States
(12) Patent Application Publication
(10) Pub. No.: US 2007/0147416 A1
(43) Pub. Date: Jun. 28, 2007

(54) Wireless modem architecture

(75) Inventors: Genevieve Cyr, Laval (CA); Jean-Francois Lacasse, Bois-des-Filion (CA); Pierre Lamoureux, St-Lazare (CA)

Correspondence Address: BERESKIN AND PARR, 40 KING STREET WEST, BOX 401, TORONTO, ON, M5H 3Y2, US

(73) Assignee: WAVESAT, Dorval (CA)

(21) Appl. No.: 11/318,522

(22) Filed: Dec. 28, 2005

(51) Int. Cl. H04J 3/22; H04J 3/18

(52) U.S. Cl. 370/465; 370/477

(57) ABSTRACT

The invention allows for a common integrated circuit PHY of a wireless modem to be used with different RF sections for making different modems by providing different RF adjustment interfaces. The RF adjustment interfaces can be provided by programmable hardware, and in some cases the same programmable hardware that is used for at least some of the MAC section of the modem.

### FIELD OF THE INVENTION

The present invention relates to wireless modems.

### BACKGROUND OF THE INVENTION

In wireless modem architecture, there is generally a radio-frequency (RF) transceiver section, a physical layer or PHY section, and a Media Access Control or MAC section. The MAC section is sometimes divided into two sections: a lower-level media access control (LL-MAC), and a high-level media access control (HL-MAC). Certain attributes of the RF section are controllable for the purposes of maintaining optimum transmission and reception properties. While in at least some cases, such attributes can be automatically controlled within the PHY section, it is more efficient to assign control over these attributes to the Programmable RF Adjustment Control Interface. Since the attributes change as a function of the RF section design, the RF section and the Programmable RF Adjustment Control Interface are designed to work hand-in-glove with one another.

The RF section deals with RF signal transmission and down conversion to intermediate frequency (IF). The physical layer deals with synchronization, equalization, modulation, forward error correction, framing and decoding of the received data. The LL-MAC performs the time critical part of the MAC such as the MAP decoder that performs real-time transmit scheduling of the subscriber station based on the information sent downlink from the base station and MAC message filtering to reduce the downlink traffic between the LL-MAC and HL-MAC. The HL-MAC provides non time critical functions like encryption and packet management. The divisions between the HL-MAC and LL-MAC sections is sometimes blurred, namely LL-MAC can included the encryption function and transport message segmentation and re-assembly.

### SUMMARY OF THE INVENTION

In some cases, it is desirable to have the RF transceiver section separate from the PHY, for example to allow for the same PHY chip to be used with different RF section designs. Different applications or operating environments may favor different RF section designs. According to some embodiments of the present invention, an RF adjustment control interface is provided to allow a common PHY device to operate with different RF sections having different RF attribute adjustments. The RF adjustment control interface is adapted for the particular requirements of the RF section design. In some embodiments, an RF section of a first design is combined with a common PHY module and a first RF adjustment interface module to manufacture first modems, while an RF section of a second design is combined with the common PHY module an a second RF adjustment interface module to manufacture second modems.

In some embodiments, the RF adjustment interface is provided using programmable hardware. It is also possible to provide the LL-MAC in programmable hardware, and also to use the same programmable hardware for both the RF adjustment interface and the LL-MAC.

In some embodiments, the HL-MAC is provided in software on a computer and a DMA to computer bus interface is provided to connect the LL-MAC to the HL-MAC over the computer's bus. In some of these embodiments, programmable hardware is used to provide the DMA interface. Of course, it is possible to use a common programmable hardware device to provide multiple devices, such as the RF adjustment interface, the LL-MAC and the DMA interface.

### BRIEF DESCRIPTION OF THE DRAWINGS

Embodiments of the invention will be better understood by way of the following detailed description thereof, in which:

FIG. 1 is a schematic block diagram of a wireless modem architecture according to a first embodiment; and

FIG. 2 is a schematic block diagram of a wireless modem architecture according to a second embodiment.

### DETAILED DESCRIPTION OF EMBODIMENTS OF THE INVENTION

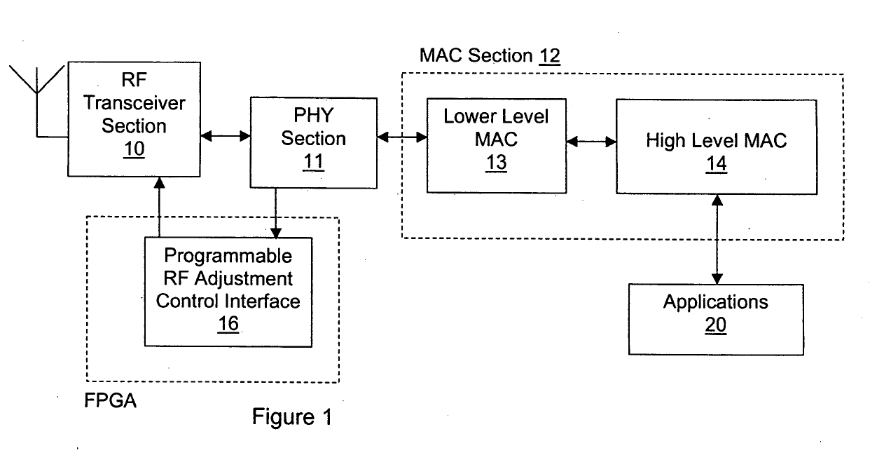

In the embodiment of FIG. 1, the PHY 11 exchanges transmit and receive IF signals with RF section 10. An FPGA chip is programmed to provide an RF adjustment control interface 16. The PHY 11 is then connected to the MAC 12 to provide the modem in the usual manner. The MAC section comprises a lower-level MAC (LL-MAC) 13 and a high-level MAC (HL-MAC) 14. The MAC 12 is used by applications 20 on a user device for communications purposes.

The choice of programmable hardware for interface 16 is advantageous for flexibility and relatively low cost. In other embodiments, the interface 16 is provided by non-programmable hardware, namely an ASIC of much less complexity than the MAC 12. The MAC 12 may be produced in relatively large volume, while the interface 16 that is designed to match the RF section 10 may be produced in relatively low volume.

The RF section attributes to be controlled by the PHY are well known in the art. As an example of such attributes in the case of an 802.16 (WiMAX) modem, the attributes may include Automatic Gain Control (AGC), Automatic level Control (ALC), Automatic Frequency Control (AFC), as well as setting of transmit and receive frequencies.

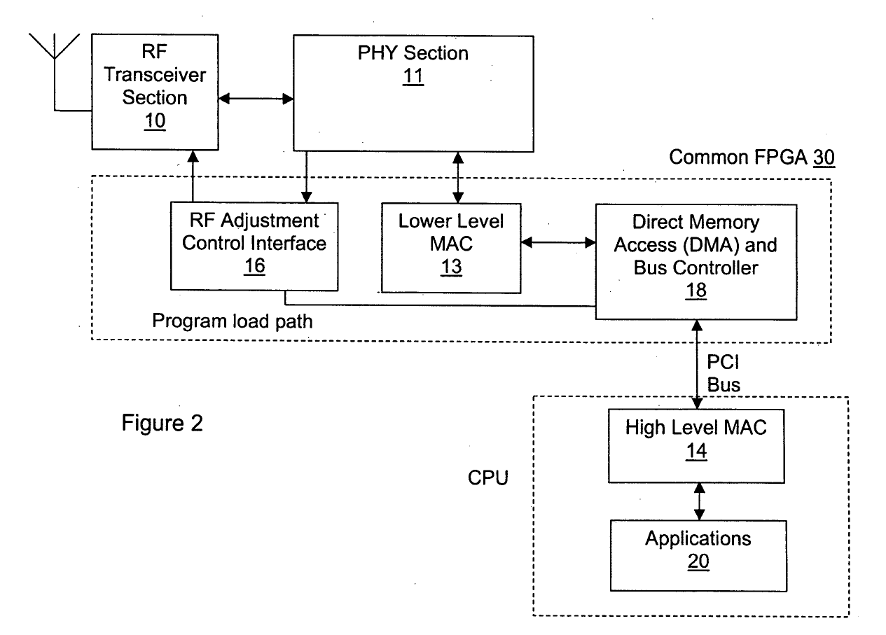

In the embodiment of FIG. 2, the LL-MAC 13 is designed to be connected to the HL-MAC 14 using a direct memory access (DMA) connection. The advantages of using DMA are known in the art. Direct memory access (DMA) allows certain hardware subsystems within a computer to access system memory for reading and/or writing independently of the CPU. Many hardware systems use DMA including disk drive controllers, graphics cards, network cards, and sound cards. DMA transfers are valuable to high performance embedded systems such as modems, and DMA is a core feature of computers, as it allows devices of different speeds to communicate without subjecting the CPU to a massive interrupt load. Otherwise, the CPU would have to copy each piece of data from the source to one of its registers, and then write it back again to the new location. During this time the CPU would be unavailable for other tasks. A DMA transfer essentially copies a block of memory from one device to another. While the CPU initiates the transfer, the transfer itself is performed by the DMA Controller. A typical example is moving a block of memory from external memory to faster, internal (on-chip) memory. Such an operation does not stall the processor, which as a result can be scheduled to perform other tasks.

By using DMA to transfer data between the LL-MAC 13 and the HL-MAC 14, certain efficiencies are gained. For example, the HL-MAC 14 may be provided in software executed on the CPU and the LL-MAC 13 may exchange data between the CPU's cache memory or another memory chip without burdening the computer bus.

In the embodiment of FIG. 2, a DMA to computer bus interface 18 is provided. Interface 18 is seen by LL-MAC 13 as DMA memory that will respond quickly to data transfer requests. Thus, the LL-MAC 1:3 has control over the DMA transfer to interface 18. Meanwhile, interface 18 manages the transfer of the data blocks over the computer bus, such as a PCI bus, in a manner that does not burden the computer bus. Thus, data received over the air is written into a buffer in interface 18 with minimal delay and then transferred over the computer bus to HL-MAC 14 quickly but in accordance with the computer bus' availability. Likewise, data sent over the air is transferred over the computer bus quickly but in accordance with bus availability to the interface 18, and the LL-MAC 13 receives the data to be transmitted as it desires by DMA transfer. The DMA interface is also described in greater detail in commonly owned co-pending US patent application filed herewith bearing the title “Wireless Modem” and agent docket number 15031-4, the specification of which is incorporated herein by reference.

In the embodiment of FIG. 2, the RF control interface 16, the LL-MAC 13 and the DMA interface 18 are all provided on a common FPGA chip. The FPGA chip has a PCI interface through which the CPU may configure the RF transceiver 10, the PHY 11 and the LL MAC 13.

In the embodiments of FIGS. 1 and 2, the RF section 10 comprises circuit components on a printed circuit board (PCB). The PHY 11 is an integrated circuit that is separate from the MAC and RF sections, and is provided on the PCB. An FPGA chip on the PCB provides interface 16 in both embodiments. In the embodiment of FIG. 1, the MAC 12 is provided by separate devices on the PCB and bus or network communications with applications 20 on a computer are provided. In the embodiment of FIG. 2, the common FPGA 30 on the PCB provides the interface 16, LL-MAC 13 and the DMA interface 18.

The PHY chip 11 also has the ability to work with different IF signal formats of the RF transceiver 10, as is described in greater detail in commonly owned co-pending US patent application filed herewith bearing the title “Signal Processing within a Wireless Modem” and agent docket number 15031-5, the specification of which is incorporated herein by reference.

We claim:

1. A wireless modem comprising:
(a) an RF section adapted to be connected to an antenna and having a set of controllable components affecting wireless signal reception and/or transmission, an intermediate frequency (IF) input and an intermediate frequency (IF) output;
(b) a physical layer (PHY) module receiving said IF output and generating said IF input, said PHY module comprising a predetermined set of RF adjustment signals, said PHY module being provided on an integrated circuit separately from said RF section; and
(c) an RF adjustment control interface module receiving said predetermined set of RF adjustment signals and providing control signals to said set of controllable components affecting wireless signal reception and/or transmission of 'said RF section, said RF adjustment control interface module being a separate device from said PHY module and said RF section.

2. The modem as claimed in claim 1, wherein said RF adjustment control interface module comprises programmable hardware.

3. The modem as claimed in claim 2, further comprising a media access control (MAC) module, wherein:
(a) said MAC module is split between a low level media access control module (LL-MAC) and a high level media access control module (HL-MAC);
(b) said LL-MAC is provided in a hardware device; and
(c) said HL-MAC is provided in software in a computer; and
(d) said LL-MAC uses direct memory access (DMA) for data exchange with said HL-MAC.

4. The modem as claimed in claim 3, wherein said LL-MAC is provided by programmable hardware.

5. The modem as claimed in claim 3, wherein said computer has a computer bus, further comprising a DMA to bus interface connecting said LL-MAC to said computer bus.

6. The modem as claimed in claim 5, wherein said LL-MAC, said bus interface and said RF adjustment control interface module are provided on a common FPGA device.

7. A method of manufacturing wireless modems comprising:
(a) providing a common physical layer (PHY) module receiving said IF output and generating said IF input, said PHY module comprising a predetermined set of RF adjustment signals;
(b) providing a first RF section adapted to be connected to an antenna and having a first set of controllable components affecting wireless signal reception and/or transmission, an intermediate frequency (IF) input and an intermediate frequency (IF) output;
(c) providing a second RF section adapted to be connected to an antenna and having a second set of controllable components affecting wireless signal reception and/or transmission, an intermediate frequency (IF) input and an intermediate frequency (IF) output;
(d) providing a first RF adjustment control interface module receiving said predetermined set of RF adjustment signals and able to providing control signals to said first set of controllable components affecting wireless signal reception and/or transmission of said RF section;
(e) providing a second RF adjustment control interface module receiving said predetermined set of RF adjustment signals and able to providing control signals to said second set of controllable components affecting wireless signal reception and/or transmission of said RF section;
(f) combining said first RF section with said common PHY module and said first interface module to manufacture first modems; and
(g) combining said second RF section with said common PHY module and said second interface module to manufacture second modems.

8. The method as claimed in claim 7, wherein said first and said second RF adjustment control interfaces comprise programmable hardware with first and second hardware programming respectively.

9. The method as claimed in claim 8, wherein said first and second hardware programming further provide a low level media access control module (LL-MAC) of a split media access control (MAC) module, wherein said MAC module is split between said LL-MAC and a high level media access control module (HL-MAC), said HL-MAC to be provided by software in a computer to be connected to said LL-MAC, said LL-MAC using direct memory access (DMA) for data exchange with said HL-MAC.

10. The method as claimed in claim 9, wherein said computer has a computer bus, said first and said second hardware programming further provide a DMA to bus interface for connecting said LL-MAC to said computer bus.
